(19) United States
(12) Patent Application Publication
(10) Pub. No.: US 2006/0224994 A1
(43) Pub. Date: Oct. 5, 2006

(54) Method, system and computer program product for preventing inadvertent selection within a graphical user interface

(75) Inventors: Srinivas Cheemalapati, Morrisville, NC (US); Jimmy Grant Foster SR., Morrisville, NC (US); Timothy J. Schlude, Cary, NC (US); Philip Louis Weinstein, Apex, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 11/096,755

(22) Filed: Apr. 1, 2005

(51) Int. Cl. G06F 3/00

(52) U.S. Cl. 715/808

(57) ABSTRACT

A method, system and computer program product for preventing inadvertent selection within a graphical user interface by temporarily intercepting any user input from a keyboard or graphical pointer which occurs within a specified short period of time following detection of an initial display of a dialog box. A second dialog box or other request for confirmation is then presented to the user, requesting confirmation of the intercepted user input prior to initiation thereof.

### BACKGROUND OF THE INVENTION

1. Field of the Invention

The present invention relates in general to a method, system and computer program product for preventing inadvertent selection within a graphical user interface; and, more specifically, to a user interface for detecting an initial display of a dialog box and preventing inadvertent selection of the default option within that dialog box.

2. Description of the Related Art

In recent years, an effort has been made to overcome the increasing complexity of computer systems by providing what has come to be known as “graphical user interface” or “GUI”. Such interfaces provide a natural and intuitive technique for a user to be able to manipulate files, programs and utilities within a modern computer system without requiring the user to enter complex command sequences. One important feature of such interfaces is the utilization of pointing devices as an input technique for the user. Such pointing devices may include a mouse, roller ball, light pen, or touch screen. Such devices are natural, intuitive and permit the user to graphically manipulate and select various actions within the computer system.

More recently, a further enhancement to this technique has been proposed. So-called “smart mouse” systems are common in modern computer systems. Smart mouse systems automatically move the pointer associated with a mouse, or other graphical pointing device, to an application-specific location within a graphical user interface, rather than requiring the mouse or pointing device to be physically relocated. This technique is frequently utilized when an application requests a confirmation operation from a user. For example, when the user selects an “Exit” menu in order to leave an application program, the application will typically display a message dialog box which consists of a question message, an “OK” button, and a “Cancel” button, in order to confirm the user's selection. From this point forward, the application does not permit the user to perform any operations other than to confirm or cancel the particular operation which initiated this process.

Smart mouse graphical user interfaces will automatically relocate the pointer associated with a graphical pointing device to the location within the display of the default response to such a dialog box.

While the aforementioned technique can quickly enhance efficiency, there may also be unintended consequences of such actions. For example, if the user has taken an action which, unbeknownst to the user, results in a dialog box being displayed with the pointer located over a default action, the user may, without conscious thought, select that default action by activating a mouse button or some similar action.

In this case, it is possible that previous actions desired by the user will be undone or files may be saved which the user did not desire within his or her system.

Consequently, it would appear that a method and system for avoiding such inadvertent action would be desirable.

### SUMMARY OF THE INVENTION

It is therefore one object of the present invention to provide a method, system and program for reducing or preventing inadvertent selection within a graphical user interface.

It is another object of the present invention to prevent such inadvertent selection within a graphical user interface while still permitting automatic relocation of a graphical pointing device pointer to a default response location within a dialog box.

The foregoing object are achieved as is now described. A method, system and computer program product are disclosed for preventing inadvertent selection within a graphical user interface by temporarily intercepting any user input from a keyboard or graphical pointer which occurs within a specified short period of time following detection of an initial display of a dialog box. A second dialog box or other request for confirmation is then presented to the user, requesting confirmation of the intercepted user input prior to initiation thereof.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed descriptions of an illustrative embodiment when read in conjunction with the accompanying drawings, in which:

FIG. 1 illustrates a computer system which may be utilized to carry out the method and system of the present invention;

FIG. 2 depicts a pictorial representation of a computer application in which the method, system and computer program product of the present invention may find application;

FIG. 3 depicts a pictorial representation of a computer application depicting the automatic location of a graphical pointer to a default response location in response to display of a dialog box in accordance with the present invention;

FIG. 4 is a pictorial representation of a mouse property selection application which permits various properties of a mouse pointer, to be selected wherein the present invention may be implemented; and

FIG. 5 is a high-level logic flowchart depicting the method of the present invention.

### DETAILED DESCRIPTION OF THE PREFERRED EMBODIMENT

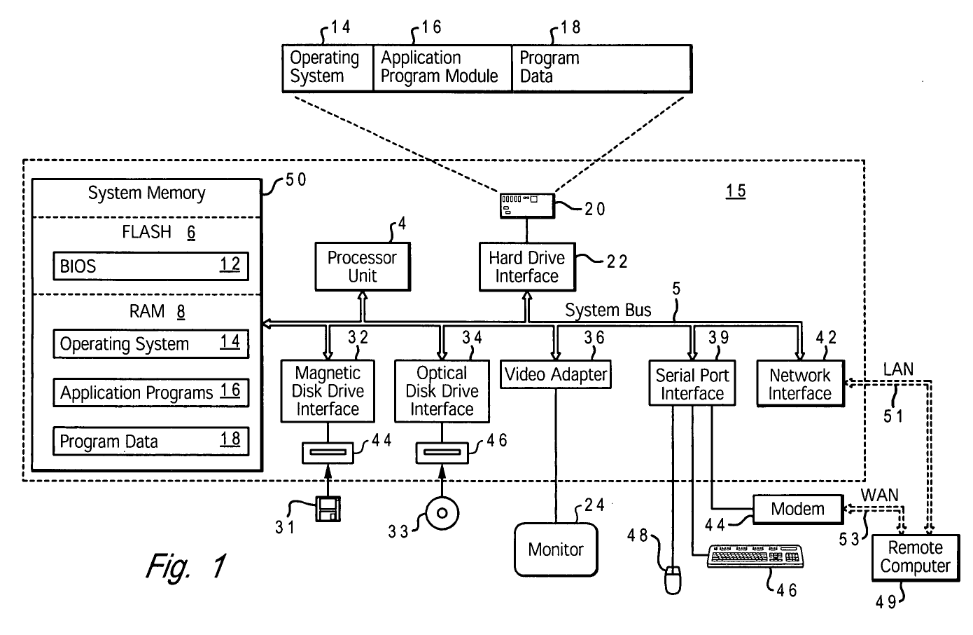

With reference now to the figures, wherein like reference numerals refer to like and corresponding parts throughout, and in particular with reference to FIG. 1, there is depicted a data processing system 15 that may be utilized to implement the method and system of the present invention. For discussion purposes, the data processing system is described as having features common to a personal computer, such as a desktop or portable computer. However, as used herein, the terms “data processing system,” “computer,” and the like are intended to mean essentially any type of computing device or machine that is capable of receiving, storing and running a software product, including such devices as communication devices (e.g., pagers, telephones, electronic books, electronic magazines and newspapers, etc.) and personal and home consumer devices (e.g., handheld computers, Web-enabled televisions, home automation systems, multimedia viewing systems, etc.).

FIG. 1 and the following discussion are intended to provide a brief, general description of an exemplary data processing system adapted to implement the present invention. While the invention will be described in the general context of an application program that runs on an operating system in conjunction with a personal computer, those skilled in the art will recognize that the invention also may be implemented in combination with other program modules. Generally, program modules include routines, programs, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementing the invention includes a data processing system 15 configured as a personal computer and thus generally comprising a processing unit 4, a system memory 50, and a system bus 5 that couples system memory 50 to processing unit 4. The system memory 50 includes flash memory 6 and random access memory (RAM) 8. Flash memory 6 is an electrically erasable programmable read only memory (EEPROM) module and includes a basic input/output system (BIOS) 12, containing the basic routines that facilitate transfer of information between elements within personal computer 15, such as during start-up. Data processing system 15 further includes a hard disk drive 20, a magnetic disk drive 44, e.g., to read from or write to a removable disk 31, and an optical disk drive 46, e.g., for reading a CD-ROM disk 33 or to read from or write to other optical media. Hard disk drive 20, magnetic disk drive 44, and optical disk drive 46 are communicatively coupled to system bus 5 by a hard disk drive interface 22, a magnetic disk drive interface 32, and an optical drive interface 34, respectively. The drives and their associated computer-readable media provide nonvolatile storage for data processing system 15. Although the description of computer-readable media above refers to a hard disk, a removable magnetic disk and a CD-ROM disk, it should be appreciated by those skilled in the art that other types of media which are readable by a computer, such as magnetic cassettes, flash memory cards, digital video disks, Bernoulli cartridges, and the like, may also be used in the exemplary computer operating environment.

A number of program modules may be stored in the drives and RAM 8, including an operating system 14, application program modules 16, such as Microsoft's OFFICE suite of program modules, and program data 18. A user may enter commands and information into data processing system 15 through a keyboard 46 and pointing device, such as a mouse 48. Other input devices (not shown) may include a microphone, joystick, game pad, satellite dish, scanner, or the like. These and other input devices are often connected to processing unit 4 through a serial port interface 39 that is coupled to system bus 5, but may be connected by other interfaces, such as a game port or a universal serial bus (USB). A monitor 24 or other type of display device is also connected to system bus 5 via an interface, such as a video adapter 36. In addition to the monitor, personal computers typically include other peripheral output devices (not shown), such as speakers or printers.

Data processing system 15 may operate in a networked environment using logical connections to one or more remote computers, such as a remote computer 49. The remote computer 49 may be a server, a router, a peer device or other common network node, and typically includes many or all of the elements described relative to data processing system 15. The logical connections depicted in FIG. 1 include a local area network (LAN) 51 and a wide area network (WAN) 53.

When used in a LAN networking environment, data processing system 15 is connected to LAN 51 through a network interface 42. When used in a WAN networking environment, data processing system 15 typically includes a modem 44 or other means for establishing communications over WAN 53, such as the Internet. The modem 44, which may be internal or external, is connected to system bus 5 via serial port interface 39. In a networked environment, program modules depicted relative to data processing system 15, or portions thereof, may be stored in the remote memory storage device. It will be appreciated that the network connections shown are exemplary and other means of establishing a communications link between the computers may be used.

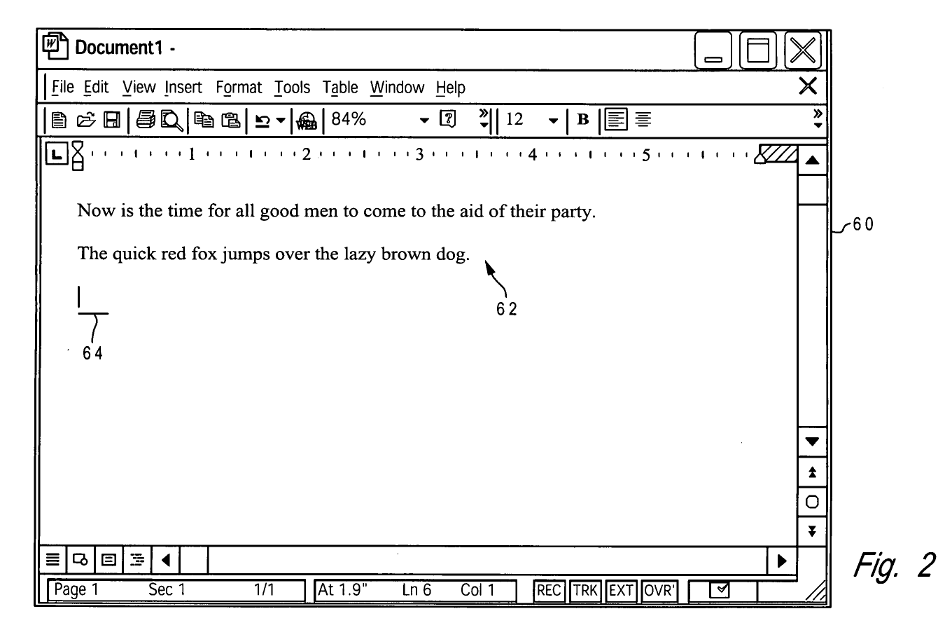

Referring now to FIG. 2, there is depicted a pictorial representation of a graphical user interface which may be displayed within monitor 24 (see FIG. 1) in which the method, system and computer program product of the present invention may be implemented. As illustrated, window 60 depicts a common word processing program into which text 62 may be typed, edited and stored for future utilization. Cursor 64 is depicted as indicating the location at which additional text would be entered upon detecting an input from the user at keyboard 46, mouse 48 or any other suitable user input device.

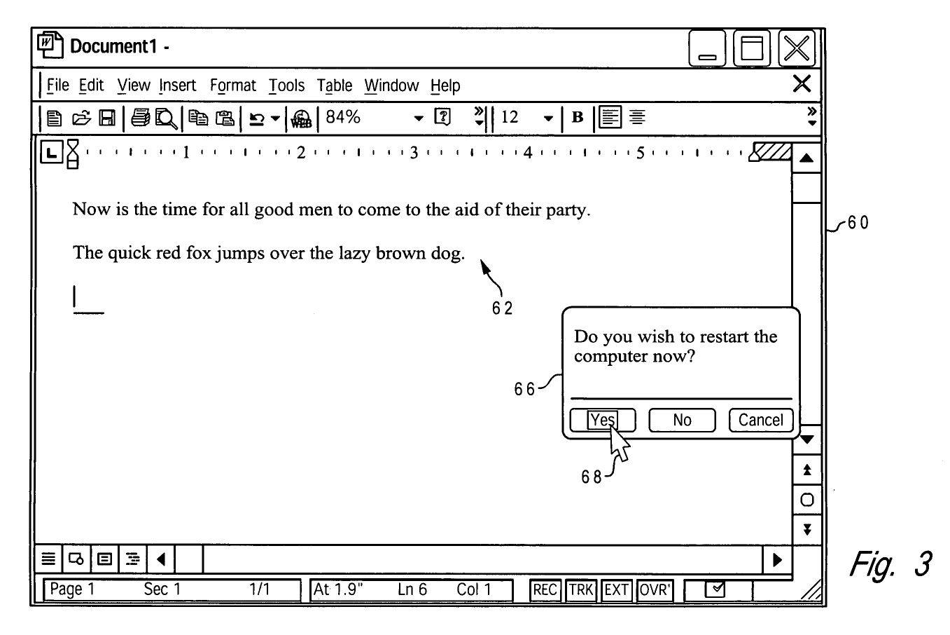

With reference now to FIG. 3, there is depicted window 60 from FIG. 2; however, at this point either an event has occurred (such as a program has finished loading) or the user has taken some action which results in the display of dialog box 66. Dialog box 66 indicates a question to the user as to whether the user wishes to restart the computer now. As illustrated, cursor 68 is depicted overlying the default (YES) response to dialog box 66.

It should be apparent to those having ordinary skill in this art that, in the event the action which has precipitated the display of dialog box 66 was not expected by the user, an inadvertent activation of a mouse button may result in changes to the document being lost, or another action that may be entirely unintended by the user. This will occur as a result of the automatic pre-positioning of cursor 68 over the default response within dialog box 66. Therefore, a method for preventing such inadvertent selection would be greatly appreciated.

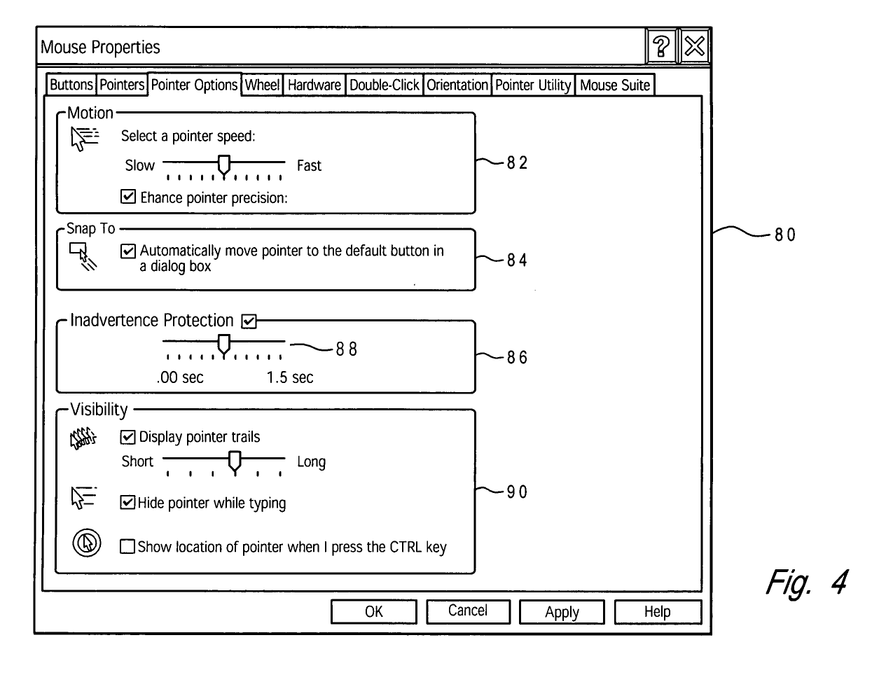

Referring now to FIG. 4, there is depicted a window 80 within which various mouse pointer options are depicted. Each pointer option typically includes a selection and various parameters associated with each selection. For example, selection 82 permits the user to dictate the speed at which the mouse pointer will relocate in response to manual relocation of the mouse.

Next, reference numeral 84 refers to the “Snap To” feature of modern mouse pointers in which the user may opt to automatically move the pointer to a default button in a displayed dialog box, as described above with respect to FIG. 3.

Box 90 within window 80 permits the user to specify various visibility features for the mouse pointer and such features are well-known to those having ordinary skill in this art.

Finally, referring to block 86, the user may select “inadvertence protection” by checking the box within this block. Further, a scroll bar 88 is provided which permits the user to specify a particular period of time during which inadvertence protection will be provided. In the depicted embodiment of the present invention, inadvertence protection may be provided, in a matter which will be explained in greater detail herein, between 0 seconds and 1.5 seconds following the display of a dialog box. Of course, those having ordinary skill in the art will appreciate that greater or lesser periods of time may be selected in accordance with personal preferences.

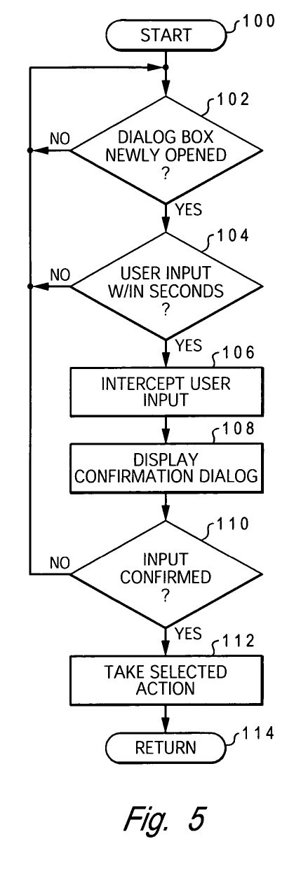

With reference now to FIG. 5, there is depicted a high-level logic flowchart which illustrates the method of the present invention. As depicted, this process begins at block 100. Next, as illustrated within block 102, the process determines whether or not a dialog box has opened and if not, the process returns, in an iterative fashion, to await the opening of a dialog box.

Still referring to block 102, in the event a dialog box has opened, the process passes to block 104. Block 104 illustrates a determination of whether or not the user has made an input to the system, utilizing a graphical pointer, keyboard or the like, within a specified short period of time (n seconds). Those having ordinary skill in this art will appreciate that in addition to mouse activation buttons, many default response buttons include a so-called “accelerator key” wherein the default action may be selected by merely striking a particular letter of the alphabet. Thus, user inputs which occur within a short specified period of time following the display of a dialog box will necessarily encompass inputs utilizing both graphical pointing devices and keyboards. In the event no user input is detected within the specified short period of time following display of a dialog box, the process returns, in an iterative fashion, to await the next opening of a dialog box. However, in the event user input is detected within that short specified period of time, the process passes to block 106.

Block 106 illustrates the temporary interception of the user input and, as depicted within block. 108, a confirmation dialog is presented. A confirmation dialog may constitute a simple graphical display inquiring if indeed the user did intend the default response, an audible warning tone, or any other technique whereby the user's attention may be drawn to the fact that a default action has been selected.

Next, the process passes to block 110. As illustrated within block 110 after the user has confirmed the input, either by selecting a confirmation button or by re-entering the previous input. The process then passes to block 112, which depicts the taking of that selected action. In the event the user has failed to confirm the input which resulted in the selection of the default action, the process returns, in an iterative fashion, to block 102 to await the opening of the next dialog box.

Referring again to block 112, after the selective action has been taken, the process passes to block 114 and returns, in an iterative fashion.

Upon reference to the foregoing, those having skill in this art will appreciate that the present application provides a technique whereby inadvertent selection of a default action as a result of automatic relocation of a graphical pointer can be avoided without diminishing the enhanced efficiency of modern graphical user interfaces.

While the invention has been particularly shown and described with reference to a preferred embodiment, it will be understood by those skilled in the art that various changes in form and detail may be made therein without departing from the spirit and scope of the invention.

What is claimed is:

1. A method for preventing inadvertent selection within a graphical user interface in a data processing system, said method comprising the steps of:
detecting an initial display of a dialog box within said graphical user interface;
detecting each user input signal; and
providing a request for user confirmation of each user input signal prior to activation thereof if said user input signal occurs within a specified short period of time following said detection of an initial display of a dialog box such that inadvertent selection of an action within said dialog box is prevented.

2. The method according to claim 1, wherein said data processing system includes a graphical pointer and wherein said step of detecting each user input signal comprises a step of detecting each selection signal from said graphical pointer.

3. The method according to claim 1, wherein said step of providing a request for user confirmation of each user input signal prior to activation thereof, if said user input signal occurs within a specified short period of time following said detection of an initial display of a dialog box comprises the step of providing a request for user confirmation of each user input signal prior to activation thereof if said user input signal occurs within one second following said detection of an initial display of a dialog box.

4. A computer system comprising:
a processor;
a user input device coupled to said processor;
a display coupled to said processor;
a graphical user interface depicted within said display;
means for detecting an initial display of a dialog box within said graphical user interface;
means for detecting user input signals from said user input device; and
means for providing a request for user confirmation of each user input signal prior to activation thereof if said user input signal occurs within a specified short period of time following said detection of an initial display of a dialog box such that inadvertent selection of an action within said dialog box is prevented.

5. The computer system according to claim 4, wherein said user input device comprises a keyboard.

6. The computer system according to claim 4, wherein said user input device comprises a mouse.

7. The computer system according to claim 5, wherein said means for detecting user input signals from said user input device comprises means for detecting keystrokes entered at said keyboard.

8. The computer system according to claim 6, wherein said means for detecting user input signals from said user input device comprises means for detecting mouse activation signals.

9. The computer system according to claim 4, wherein said means for providing a request for user confirmation comprises means for displaying a dialog box requesting a user entry to confirm said user input signal.

10. A computer program product for utilization in a computer system having a graphical user interface, said computer program product comprising:
computer storage media;
instructions embedded within said computer storage media for causing a detection of an initial display of a dialog box within said graphical user interface;
instructions embodied within said computer storage media for causing detection of each user input signal;
instructions embodied within said computer storage media for causing a request for user confirmation of each user input signal prior to activation thereof if said user input signal occurs within a specified short period of time following said detection of an initial display of a dialog box such that inadvertent selection of an action within said dialog box is prevented.
